(19) United States
(12) Patent Application Publication
(10) Pub. No.: US 2014/0272854 A1
(43) Pub. Date: Sep. 18, 2014

(54) EXERCISE MAT

(71) Applicant: Yoga by Numbers, Inc., Belmont, MA (US)

(72) Inventor: ELIZABETH J. MORROW, Belmont, MA (US)

(73) Assignee: Yoga by Numbers, Inc., Belmont, MA (US)

(21) Appl. No.: 14/076,733

(22) Filed: Nov. 11, 2013

Related U.S. Application Data
(60) Provisional application No. 61/783,017, filed on Mar. 14, 2013.

(51) Int. Cl. G09B 1/32

(52) U.S. Cl. CPC G09B 1/32
USPC 434/247

(57) ABSTRACT

An exercise mat including a flexible sheet member. A plurality of targets are positioned on at least a first surface of the flexible sheet member. Each of the plurality of target includes a verbally-definable unique identifier.

### RELATED APPLICATION

This application claims the benefit of U.S. Provisional Patent Application Ser. No. 61/783,017, filed on 14 Mar. 2013, of which the entire contents are incorporated herein by reference.

### TECHNICAL FIELD

This disclosure relates to exercise mats and, more particularly, to yoga exercise mats.

### BACKGROUND

During many exercise classes, the instructor of the class provides verbal instructions to the students in the class. The manner in which the students move and position their bodies is of high importance, as improper positioning may result in e.g., a lower quality workout and/or physical injury. Often and unfortunately, students position themselves improperly, especially when not working one on one with an instructor. Further, when students practice at home, it is difficult for the student to ensure that they are in proper alignment.

For example and in yoga classes, the instructor may teach the class by providing verbal instructions to the students, such as “Please come into Warrior Two position”, wherein the student is required to bring their right foot forward and their left foot back into a lunge position. Unfortunately, novice yoga students may lack knowledge of these particular positions. Furthermore, while somewhat experienced yoga students may remember the manner in which to position their body (e.g., right foot forward and left foot back into a lunge position), they may lack the experience to know the degree of these individual movements. For example, how far should they move their right foot forward? And how far should they move their left foot backward? And to what angle should they point their toes? Accordingly, these students may interpret these verbal instructions in many different ways that may result in improper positing on the limbs of the student and (as discussed above) physical injury, such as injuries to muscles and joints.

In order to avoid such a situation, the instructor may need to manually reposition the students in the class to place them into the proper (and safe) position. As could be imagined, such manual repositioning of students may slow the overall progress of the class and may result in the more experienced students rapidly losing interest in the class. Accordingly, it would be difficult at best for students to evaluate their own alignment, so they would need to depend upon a teacher to provide individual instruction.

### SUMMARY OF DISCLOSURE

In one implementation, an exercise mat includes a flexible sheet member. A plurality of targets are positioned on at least a first surface of the flexible sheet member. Each of the plurality of target includes a verbally-definable unique identifier.

One or more of the following may be included. The exercise mat may be a yoga exercise mat. The unique identifier may be a number. Each of the plurality of targets may include a rotational position indicator. The plurality of targets may be positioned in a grid format. The grid format may include at least four target columns. The plurality of targets may be printed onto the flexible sheet member. The plurality of target may be embossed into the flexible sheet member. The flexible sheet member may be constructed of an energy absorbing material. The flexible sheet member may be constructed of one or more of: polyvinyl chloride (PVC); natural rubber; jute; thermoplastic elastomer (TPE); cloth/fabric; and bamboo. At least a second surface of the flexible sheet member may be a non-skid surface.

In another implementation, a yoga exercise mat includes a flexible sheet member constructed of an energy absorbing material. A plurality of targets are positioned in a grid format on at least a first surface of the flexible sheet member. Each of the plurality of target includes a unique identifier.

One or more of the following features may be included. The unique identifier may be a number. Each of the plurality of targets may include a rotational position indicator. The grid format may include at least four target columns. The plurality of targets may be printed onto the flexible sheet member. The plurality of target may be embossed into the flexible sheet member.

In another implementation, a yoga exercise mat includes an energy absorbing flexible sheet member including a first surface and a second surface. A plurality of targets are positioned in a grid format on the first surface of the flexible sheet member. Each of the plurality of target includes a unique identifying number, and a rotational position indicator. The second surface of the flexible sheet member is a non-skid surface.

One or more of the following features may be included. The grid format may include at least four target columns. The energy absorbing flexible sheet member may be constructed of one or more of: polyvinyl chloride (PVC); natural rubber; jute; thermoplastic elastomer (TPE); cloth/fabric; and bamboo.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an exercise mat according to an implementation of this disclosure;

FIG. 2 is another diagrammatic view of the exercise mat of FIG. 1 according to an implementation of this disclosure;

FIG. 3 is another diagrammatic view of the exercise mat of FIG. 1 according to an implementation of this disclosure;

FIG. 4 is another diagrammatic view of the exercise mat of FIG. 1 according to an implementation of this disclosure;

FIG. 5 is a diagrammatic view of a plurality of targets included on the exercise mat of FIG. 1 according to an implementation of this disclosure; and

FIG. 6 is a detail view of one of the targets included on the exercise mat of FIG. 5 according to an implementation of this disclosure.

Like reference symbols in the various drawings indicate like elements.

### DETAILED DESCRIPTION

Referring to FIG. 1, there is shown exercise mat 10. While the following discussion describes exercise mat 10 being configured as a yoga exercise mat, this is for illustrative purposes only and is not intended to be a limitation of this disclosure, as other configurations are possible and are considered to be within the scope of this disclosure. For example, exercise mat 10 may be configured as a pilates mat or an aerobics mat.

Exercise mat 10 may include flexible sheet member 12. Flexible sheet member 12 may be constructed of an energy absorbing material, examples of which may include but are not limited to: polyvinyl chloride (PVC); natural rubber; jute; cloth/fabric; and thermoplastic elastomer (TPE). When exercise mat 10 is configured in this fashion, exercise mat 10 may be rolled up for storage (as shown in FIG. 2).

Alternatively, flexible sheet member 12 may be constructed of a more rigid material, an example of which may include but is not limited to bamboo. When constructed of such a material, parallel strips of bamboo may be fastened together (as shown in FIG. 3) so that exercise mat 10 may be rolled up for storage (as shown in FIG. 2).

Alternatively still, flexible sheet member 12 may be constructed from a combination of materials. For example, flexible sheet member 12 may include a sheet of natural rubber to which a layer of bamboo is bonded. Such bamboo may be bonded to the sheet of natural rubber as parallel strips, thus allowing flexible sheet member 12 to be rolled up for storage (as shown in FIG. 2).

While flexible sheet member 12 is shown as being of unitary design, this is for illustrative purposes only and is not intended to be a limitation of this disclosure. For example, flexible sheet member 12 may be configured in a multi-piece fashion similar to a jigsaw puzzle (as shown in FIG. 4), so that flexible sheet member 12 may be assembled for use and disassembled for easy storage.

As will be discussed below in greater detail, a first surface (e.g., upper surface 14) of flexible sheet member 12 may include a plurality of targets that are positioned in defined locations about upper surface 14 of flexible sheet member 12.

A second surface (e.g., lower surface 16) of flexible sheet member 12 may be a non-skid surface. For example, lower surface 16 may be constructed of a material that naturally has a high coefficient of friction, thus preventing the inadvertent/unintentional movement of exercise mat 10 when is use by user 18. Alternatively, lower surface 16 of flexible sheet member 12 may include a plurality of friction enhancing devices (such as suction cups; not shown) that may temporarily adhere flexible sheet member 12 to the floor (in a fashion similar to a bath mat), thus preventing the inadvertent/unintentional movement of exercise mat 10 when is use by user 18.

Referring also to FIG. 5 and as discussed above, upper surface 14 of flexible sheet member 12 may include a plurality of targets that are positioned in defined locations about upper surface 14.

In this particular example, upper surface 14 of flexible sheet 12 is shown to include twenty-eight targets that are labeled #01-#28, configured in a grid having four columns and seven rows. However, this is for illustrative purpose only and is not intended to be a limitation of this disclosure, as other configurations are possible. For example, the quantity of rows and/or columns included within the gird of targets may be increased/decreased based upon the particular type of exercise for which exercise mat 10 is configured.

Each of the plurality of targets on upper surface 14 of flexible sheet 12 may include a verbally-definable unique identifier so that a specific target may be easily identified by the exercise instructor when teaching an exercise class using exercise mat 10. For example, if exercise mat 10 is configured for use in a yoga class, instead of the yoga instructor saying “Please come into Warrior Two position and bring your right foot forward and your left foot back into a lunge position”, the yoga instructor may say “Please come into Warrior Two position and place your right foot into #07 and your left foot in #22”. Accordingly and through the use of such verbally-definable unique identifiers, any ambiguity concerning where a user of exercise mat is supposed to position their feet is eliminated, thus allow beginners and experts alike to follow along with the class. Additionally, proper alignment may be achieved by saying “Align the heel of your front foot with the arch of your back foot using the imprinted gridlines.” Such simple commands may be especially useful when the students have low language skills (e.g., in ESL classes with people that are learning English).

In this illustrative embodiment of exercise mat 10, upper surface 14 of flexible sheet 12 is shown to include twenty-eight targets, each of which includes a unique identifier (namely #01-#28). However, the specific labels illustrated in FIG. 5 are for illustrative purposes only and are not intended to be a limitation of this disclosure, as other configurations are possible and are considered to be within the scope of this disclosure. For example, letter-based unique identifiers and/or color-based unique identifiers may be included on upper surface 14 of flexible sheet 12.

The plurality of targets on upper surface 14 of flexible sheet 12 may be printed onto upper surface 14 of flexible sheet 12 (e.g., using a silk-screening process). Alternatively, the plurality of targets on upper surface 14 of flexible sheet 12 may be embossed into upper surface 14 of flexible sheet 12 (e.g., using a thermal-stamping process).

Referring also to FIG. 6, each of the above-described plurality of targets (which in this example are labeled #01-#28) may include a rotational position indicator. For example, the target labeled #01 is shown to include a rotational position indictor that includes four alignment marks, namely alignment mark 50 (located at the three o'clock position); alignment mark 52 (located at the six o'clock position); alignment mark 54 (located at the nine o'clock position); and alignment mark 56 (located at the twelve o'clock position). While the rotational position indicator is shown to include four discrete alignment marks, this is for illustrative purposes only, as other configurations are possible and are considered to be within the scope of this disclosure. For example, the quantity of alignment marks may be increased/decreased depending upon the level of rotational granularity required by the exercise being performed.

Through the use of such rotational position indicators, the instructor of the exercise class may instruct the students concerning the direction in which their feet should be pointed. For example, the yoga instructor may say “Please come into Warrior Two position and place your right foot into #07 @ 12:00 and your left foot in #22” @ 11:00, further clarifying the correct position for the students of the class.

A number of implementations have been described. Nevertheless, it will be understood that various modifications may be made. Accordingly, other implementations are within the scope of the following claims.

What is claimed is:

1. An exercise mat comprising:
a flexible sheet member; and
a plurality of targets positioned on at least a first surface of the flexible sheet member, wherein each of the plurality of target includes a verbally-definable unique identifier.

2. The exercise mat of claim 1 wherein the exercise mat is a yoga exercise mat.

3. The exercise mat of claim 1 wherein the unique identifier is a number.

4. The exercise mat of claim 1 wherein each of the plurality of targets includes a rotational position indicator.

5. The exercise mat of claim 1 wherein the plurality of targets are positioned in a grid format.

6. The exercise mat of claim 5 wherein the grid format includes at least four target columns.

7. The exercise mat of claim 1 wherein the plurality of targets are printed onto the flexible sheet member.

8. The exercise mat of claim 1 wherein the plurality of target are embossed into the flexible sheet member.

9. The exercise mat of claim 1 wherein the flexible sheet member is constructed of an energy absorbing material.

10. The exercise mat of claim 1 wherein the flexible sheet member is constructed of one or more of: polyvinyl chloride (PVC); natural rubber; jute; thermoplastic elastomer (TPE); cloth/fabric; and bamboo.

11. The exercise mat of claim 1 wherein at least a second surface of the flexible sheet member is a non-skid surface.

12. A yoga exercise mat comprising:
a flexible sheet member constructed of an energy absorbing material; and
a plurality of targets positioned in a grid format on at least a first surface of the flexible sheet member, wherein each of the plurality of target includes a unique identifier.

13. The yoga exercise mat of claim 12 wherein the unique identifier is a number.

14. The yoga exercise mat of claim 12 wherein each of the plurality of targets includes a rotational position indicator.

15. The yoga exercise mat of claim 12 wherein the grid format includes at least four target columns.

16. The yoga exercise mat of claim 12 wherein the plurality of targets are printed onto the flexible sheet member.

17. The yoga exercise mat of claim 12 wherein the plurality of target are embossed into the flexible sheet member.

18. A yoga exercise mat comprising:
an energy absorbing flexible sheet member including a first surface and a second surface; and
a plurality of targets positioned in a grid format on the first surface of the flexible sheet member, wherein each of the plurality of target includes:
a unique identifying number, and
a rotational position indicator;
wherein the second surface of the flexible sheet member is a non-skid surface.

19. The yoga exercise mat of claim 18 wherein the grid format includes at least four target columns.

20. The yoga exercise mat of claim 18 wherein the energy absorbing flexible sheet member is constructed of one or more of: polyvinyl chloride (PVC); natural rubber; jute; thermoplastic elastomer (TPE); cloth/fabric; and bamboo.
